(19) United States
(12) Patent Application Publication
(10) Pub. No.: US 2017/0101312 A1
(43) Pub. Date: Apr. 13, 2017

(54) INDUCTIVE HEATING OF A STEAM REFORMER FURNACE

(71) Applicant: Dieter Mihailowitsch, Geretsried (DE)

(72) Inventor: Dieter Mihailowitsch, Geretsried (DE)

(21) Appl. No.: 15/284,615

(22) Filed: Oct. 4, 2016

(30) Foreign Application Priority Data
Oct. 8, 2015 (DE) 102015013071.4

(51) Int. Cl. C01B 3/38; B01J 8/06

(52) U.S. Cl. CPC C01B 3/384; B01J 8/062; B01J 8/067; B01J 2208/00504; B01J 2208/065; C01B 2203/0233; C01B 2203/0816

(57) ABSTRACT

A furnace and method for steam reforming of a hydrocarbon-containing feed stream, which particularly comprises methane, with: a combustion chamber, at least one reactor tube, which in portions extends in the combustion chamber and is designed for receiving a catalyst and for passing the feed stream through, and at least one burner, which is designed to burn a fuel in the combustion chamber for heating the at least one reactor tube is disclosed. It is provided that the at least one reactor tube has a portion of tube running above and outside the combustion chamber, an inductor which is designed for inductively heating the portion of tube being arranged on the portion of tube.

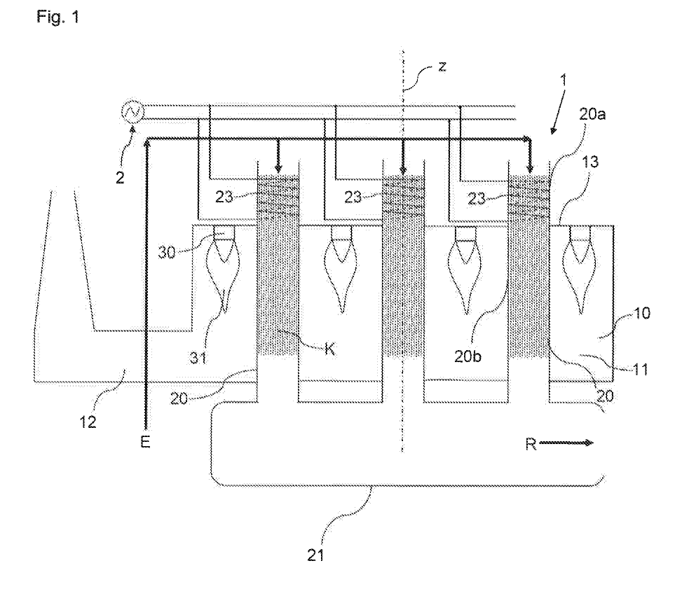

### CROSS REFERENCE TO RELATED APPLICATIONS

This application claims priority from German Patent Application DE 102015013071.4 filed on Oct. 8, 2015.

### BACKGROUND OF THE INVENTION

The invention relates to a furnace, for example for carrying out steam reforming of a hydrocarbon-containing feed gas stream, and also to a corresponding method.

Steam reforming, in particular of methane, is a widely used, established technology for producing synthesis gas. Steam reforming is also currently preferred over other methods, in particular for producing hydrogen.

Steam reforming is an allothermic reaction which, for example in the case of natural gas or methane as the feedstock, proceeds according to the following reaction equation in the presence of a suitable catalyst:

CH₄+H₂O−>CO+3H₂.

The reaction is carried out by mixing preferably hot steam with the feedstock (for example natural gas or methane) to be reformed and, with constant input of energy provided by burning a fuel, reacting the mixture in the presence of the catalyst in the gas phase to yield synthesis gas or hydrogen.

Against this background, the object of the invention is that of providing an improved apparatus and an improved method for producing synthesis gas, in particular hydrogen.

### SUMMARY OF THE INVENTION

This object is achieved by a furnace for steam reforming of a hydrocarbon-containing feed stream. Advantageous embodiments of the invention are stated in the associated subclaims and are described below.

Thus, according to the invention a furnace for steam reforming a hydrocarbon-containing feedstock, in particular comprising methane is disclosed, the furnace comprising:
a combustion chamber,
at least one reactor tube, which in portions extends in the combustion chamber and is designed for receiving a catalyst and for passing the feed stream through, and
at least one burner, which is designed to burn a fuel in the combustion chamber for heating the at least one reactor tube,
   the at least one reactor tube having a portion of tube running above and outside the combustion chamber and an inductor which is designed for inductively heating the portion of tube being arranged on the portion of tube. That is to say that the inductor is designed to generate an alternating magnetic field which induces in the material of the portion of tube eddy currents that lead to the heating of the portion of tube.

In other words, the at least one reactor tube may be led out of the combustion chamber through an upper (in particular horizontal) wall of the combustion chamber, so that that particular portion of tube of the at least one reactor tube extends above and outside the combustion chamber.

In comparison with resistance heating of reactor tubes, there are advantageously no problems with the galvanic isolation of the reactor tubes from the rest of the construction.

In principle, the furnace may of course have a number of reactor tubes with corresponding portions of tube on which an inductor is respectively arranged being arranged above and outside the combustion chamber.

The invention thus makes use of established steam reforming technology particularly for producing synthesis gas or hydrogen, the technical teaching according to the invention providing a basis for the advantageous possibility that, for example when surplus electrical energy or inexpensive electrical energy is available, at least some of the fuel can be saved and the heating of the feed stream can be assisted or temporarily replaced by inductive heating of the reactor tubes.

According to a preferred embodiment of the furnace according to the invention, the burner or a plurality of burners is/are arranged on an upper wall of the combustion chamber, which upwardly delimits the combustion chamber, the burners preferably being configured to fire downwardly into the combustion chamber. As an alternative to this, the burners may also be arranged on the sides of the combustion chamber or at the bottom of the combustion chamber (for example on a base of the combustion chamber).

According to a preferred embodiment of the furnace according to the invention, it is also provided that the at least one reactor tube or the number of reactor tubes open(s) into a manifold, via which a stream of raw product or raw synthesis gas from steam reforming which is taking place in the reactor tube or in the reactor tubes in the presence of a suitable catalyst can be drawn off from the reactor tube or the reactor tubes.

The at least one reactor tube preferably extends along a longitudinal or cylinder axis, which runs parallel to the vertical. If a number of reactor tubes are provided, they preferably extend parallel to one another along a longitudinal or cylinder axis each, which respectively extend parallel to the vertical.

The said portion or portions of tube in this case preferably extend above and outside the combustion chamber with respect to this (these) longitudinal axis (axes) and the vertical.

The manifold is arranged below and outside (or alternatively inside) the combustion chamber with respect to the vertical and preferably extends transversely in relation to the at least one reactor tube or along the horizontal.

With burners arranged at the bottom of the combustion chamber (see above), the manifold may also be arranged above the combustion chamber.

The at least one reactor tube and/or the manifold may at least in portions be of a hollow-cylindrical, in particular hollow-circular-cylindrical, form. Other cross-sectional shapes are also conceivable. Furthermore, the at least one reactor tube preferably consists of an electrically conductive material or comprises at least one such material, so that inductive heating of the at least one reactor tube is possible.

According to one embodiment of the invention, it is also provided that the inductor is provided downstream of a location on the said portion of tube at which the feed stream can be introduced into the at least one reactor tube, and upstream of (for example above and outside) the said combustion chamber.

According to one embodiment of the invention, it is also provided that the inductor has a coil, which is wound around the said portion of tube.

According to one embodiment of the invention, it is also provided that the inductor is connected or can be connected to an energy source, which generates an alternating current in the inductor, so that the said alternating magnetic field is generated, which causes in the said portion of tube eddy currents that lead to the heating of the portion of tube.

According to one embodiment of the invention, it is also provided that the said portion of tube is designed likewise to receive that particular catalyst or a catalyst or that the portion of tube is filled with the catalyst. The catalyst material is consequently preferably located not only inside the combustion chamber but also above the combustion chamber in said portion of tube, so that steam reforming that uses inductively generated heat can also be carried out there. In particular, the inductors may in this case be arranged alongside the catalyst. Thus, for example, the said coils may respectively enclose the catalyst located in the respective portion of tube, so that heat can be generated in particular directly in the enclosed catalyst material, in order to make steam reforming possible there.

A further aspect of the invention relates to a method for steam reforming using a furnace as described herein.

The method according to the invention preferably uses a furnace according to the invention and may be further developed in particular with reference to the features described above.

The method according to the invention provides that a hydrocarbon-containing feed stream, in particular containing methane, and comprising steam is passed through at least one reactor tube (or a number of reactor tubes) of a furnace and reacted there in the presence of a suitable catalyst arranged in the at least one reactor tube to yield a stream of raw synthesis gas comprising CO and H₂, the feed stream in the at least one reactor tube being passed through a combustion chamber in which a fuel is combustible or is burned for heating the feed stream. According to the invention, the feed stream in the at least one reactor tube is at least temporarily additionally heated by the at least one reactor tube being inductively heated, or instead of heating the feed stream by burning the fuel, the at least one reactor tube is at least temporarily inductively heated.

### BRIEF DESCRIPTION OF THE DRAWINGS

Further features and advantages of the present invention are to be explained in the description of exemplary embodiments on the basis of the FIGURE, in which:

The FIGURE shows a perspective representation of a furnace according to the invention in the form of a cutout.

### DETAILED DESCRIPTION OF THE INVENTION

The FIGURE shows a furnace 1 according to the invention for steam reforming a hydrocarbon-containing feed stream E, which particularly comprises methane. The furnace 1 has a combustion chamber 10, which has a radiation zone 11 and a convection zone 12. In the radiation zone 11, burners 30, which are designed to burn a fuel in the presence of oxygen in the combustion chamber 10 or radiation zone 11, are provided for example on an upper horizontal wall 13 of the combustion chamber 10, the resultant heat being transferred to a plurality of reactor tubes 20 (or at least one reactor tube 20, see above), just three of which are shown here for the sake of simplicity. The reactor tubes 20 respectively extend along a vertical longitudinal axis z through the radiation zone 11 of the combustion chamber 10. A catalyst K is provided in the reactor tubes 20. This catalyst is provided here in a portion of tube 20b of the respective reactor tube 20 that runs inside the combustion chamber 10 and also in a portion of tube 20a of the respective reactor tube 20 that is respectively provided above and outside the combustion chamber 10.

The heat generated in the radiation zone 11 is set in particular such that the feed stream E introduced into the reactor tubes 20, which has in particular previously been preheated in the convection zone 12 of the furnace 1 or the combustion chamber 10, is reacted by steam reforming in the reactor tubes 20 using said heat to yield a stream of raw synthesis gas R which comprises CO and H₂.

The reactor tubes 20 open here into a manifold 21, which is provided under the combustion chamber 10 and via which the stream of raw synthesis gas R which has been produced can be drawn off from the furnace 1 or the reactor tubes 20.

The reformed gas R leaves the radiation zone 11 of the reformer furnace 1 generally for example in a temperature range of 780° C. to 1050° C., preferably 820° C. to 950° C. The pressure range of the gas is preferably in the range from 10 bar to 50 bar, preferably 15 to 40 bar.

According to the invention, the furnace 1 then has in addition to the burners 30 inductors 23, which are arranged on the upper portions of tube 20a and are configured for inductively heating the portions of tube 20a. For this purpose, the inductors may have electrically conducting coils 23, which are respectively wound around an assigned portion of tube 20a, the individual inductors or coils 23 being connected to an energy source 2, which produces in the inductors 23 a flow of current that generates an alternating magnetic field, which in turn produces in the portions of tube 20a eddy currents that lead to the heating of the respective portion of tube 20a.

According to the invention, electrical energy may thus be used instead of the fuel or in addition to the fuel for heating the feed stream E. The electrical energy is preferably surplus energy or particularly inexpensive energy.

The furnace 1 according to the invention is particularly suitable for carrying out the method according to the invention. In this respect, the technical teaching of the present invention makes it possible that, in addition to the firing, the feed stream E in the reactor tubes 20 can for example be temporarily heated by an electrical eddy current being inductively generated by means of the inductors or coils 23 in each case in the way described above in the portions of tube of the reactor tubes 20 that are likewise filled with catalyst. Furthermore, instead of the firing, the said portions of tube 20a of the reactor tubes 20 may in particular be temporarily inductively heated respectively for heating the feed stream E. The invention consequently advantageously makes it possible for amounts of energy that are in particular surplus to requirements, and possibly particularly inexpensive electrical energy, to be included in a steam reforming process.

List of reference signs

| | |
|---|---|
| 1 | Furnace |
| 2 | Energy source |
| 10 | Combustion chamber |
| 11 | Radiation zone |
| 12 | Convection zone |
| 13 | Wall |
| 20 | Reactor tube |
| 20a, 20b | Portion of tube |
| 21 | Manifold |
| 23 | Inductor (for example coil) |
| R | Stream of raw synthesis gas |
| Z | Longitudinal axis |

What I claim is:

1. A furnace for steam reforming of a hydrocarbon-containing feed stream, with:
a combustion chamber,
at least one reactor tube, which in portions extends in the combustion chamber and is designed for receiving a catalyst and for passing the feed stream through, and
at least one burner, which is designed to burn a fuel in the combustion chamber for heating the at least one reactor tube,
characterized
in that the at least one reactor tube has a portion of tube running above and outside the combustion chamber and an inductor which is designed for inductively heating the portion of tube being arranged on the portion of tube.

2. The furnace according to claim 1, characterized in that the inductor has a coil, which is wound around the said portion of tube.

3. The furnace according to claim 1, characterized in that the said portion of tube is designed to receive the catalyst, or in that the portion of tube is filled with the catalyst.

4. A method for steam reforming in a furnace wherein a hydrocarbon-containing and steam-comprising feed stream is passed through at least one reactor tube of the furnace and reacted there in the presence of a catalyst arranged in the at least one reactor tube to yield a stream of raw synthesis gas, the feed stream being passed in the at least one reactor tube through a combustion chamber, in which a fuel is burned for heating the feed stream,
characterized
in that the feed stream in the at least one reactor tube is at least temporarily additionally heated by the at least one reactor tube being inductively heated, or in that
instead of heating the feed stream by burning the fuel, the at least one reactor tube is at least temporarily inductively heated.

5. The method according to claim 4, characterized in that the at least one reactor tube has a portion of tube running above and outside the combustion chamber.

6. The method according to claim 4, characterized in that the inductor has a coil, which is wound around the said portion of tube.

7. The method according to claim 4, characterized in that the said portion of tube is designed to receive the catalyst, or in that the portion of tube is filled with the catalyst.
